(19) United States
(12) Patent Application Publication
(10) Pub. No.: US 2022/0166008 A1
(43) Pub. Date: May 26, 2022

(54) Anode Active Material for All-Solid-State Battery Comprising Carbon-Based Material and Silicon-Based Material and Method of Manufacturing Same

(71) Applicants: Hyundai Motor Company, Seoul (KR); Kia Corporation, Seoul (KR); Ulsan National Institute of Science and Technology, Ulsan (KR)

(72) Inventors: Sung Woo Noh, Seoul (KR); Ju Yeong Seong, Suwon-si (KR); Yong Gu Kim, Suwon-si (KR); In Woo Song, Gwacheon-si (KR); Hong Seok Min, Yongin-si (KR); Yong Sub Yoon, Seoul (KR); Yun Sung Kim, Seoul (KR); A Reum Ha, Ulsan (KR); Yong Jun Jang, Seongnam-si (KR); Sang Heon Lee, Yongin-si (KR); Ki Hong Ahn, Ulsan (KR); Jae Phil Cho, Ulsan (KR)

(21) Appl. No.: 17/512,814

(22) Filed: Oct. 28, 2021

(30) Foreign Application Priority Data
Nov. 24, 2020 (KR) 10-2020-0158559

(51) Int. Cl. H01M 4/36; H01M 4/587; H01M 4/133; H01M 4/134; H01M 4/04

(52) U.S. Cl. CPC H01M 4/366; H01M 4/587; H01M 2004/021; H01M 4/134; H01M 4/0428; H01M 4/133

(57) ABSTRACT

An embodiment anode active material for an all-solid-state battery includes a carbon-based material including carbon-based particles and a coating layer formed on a surface of the carbon-based particles, the coating layer comprising amorphous carbon, and a silicon-based material. An embodiment method of manufacturing an anode active material for an all-solid-state battery includes manufacturing a carbon-based material by forming a coating layer including amorphous carbon from a hydrocarbon gas on a surface of carbon-based particles through thermal chemical vapor deposition, manufacturing a silicon-based material through thermal chemical vapor deposition using a feed comprising silane gas and ammonia gas, and mixing the carbon-based material and the silicon-based material.

### CROSS-REFERENCE TO RELATED APPLICATIONS

The present application claims the benefit of Korean Patent Application No. 10-2020-0158559, filed on Nov. 24, 2020, which application is hereby incorporated herein by reference.

### TECHNICAL FIELD

The present disclosure relates to an anode active material for an all-solid-state battery including a carbon-based material and a silicon-based material and a method of manufacturing the same.

### BACKGROUND

With a rapid increase in the demand for the Internet of Things (IoT) and a Battery of Things (BoT), interest in the safety of lithium secondary batteries is growing.

Currently widely used lithium secondary batteries mainly use a liquid electrolyte, which is an organic solvent, but there is a risk of explosion due to an increase in temperature or an internal short circuit in the case of the liquid electrolyte. In order to solve this problem, all-solid-state batteries using solid electrolytes have been developed. Since all-solid-state batteries are very safe, they are regarded as having an advantage over other batteries in terms of simplification of safety devices and productivity.

However, one of the big problems of applying a solid electrolyte instead of a liquid electrolyte is that desired electrochemical performance is not realized due to physical and chemical reactions occurring at the interface between the active material and the solid electrolyte particles.

Meanwhile, a carbon-based material such as graphite activated carbon, etc. or a silicon-based material such as silicon oxide (SiOₓ), etc. is used as the anode active material of the all-solid-state battery.

The carbon-based material has a disadvantage in that the theoretical capacity thereof is only about 400 mAh/g, so the capacity thereof is small. Accordingly, attempts have been made to use silicon (Si) or lithium metal, having high theoretical capacity, in order to improve the energy density, but there are difficulties such as high irreversible capacity, high volume expansion rate, formation of dendrites, and the like.

### SUMMARY

Therefore, an embodiment of the present disclosure provides an all-solid-state battery having superior interfacial stability of an anode active material and a solid electrolyte.

Another embodiment of the present disclosure provides an all-solid-state battery having improved capacity and a prolonged lifetime by applying a silicon-based material, which contains nitrogen (N) and thus exhibits superior structural stability upon electrochemical charging and discharging, as an anode active material together with a carbon-based material.

The embodiments of the present disclosure are not limited to the foregoing, and will be able to be clearly understood through the following description and to be realized by the means described in the claims and combinations thereof.

An embodiment of the present disclosure provides an anode active material for an all-solid-state battery, including a carbon-based material and a silicon-based material, in which the carbon-based material may include carbon-based particles and a coating layer formed on the surface of the carbon-based particles and including amorphous carbon.

The carbon-based particles may include at least one selected from the group consisting of synthetic graphite, natural graphite, and combinations thereof.

The average particle diameter (D₅₀) of the carbon-based particles is 10 μm or less.

The thickness of the coating layer may be 15 nm to 20 nm.

The carbon-based material may include 90 wt % to 95 wt % of the carbon-based particles and 5 wt % to 10 wt % of the coating layer.

The silicon-based material may include a compound represented by SiNₓ (0<x<2).

The average particle diameter (D₅₀) of the silicon-based material may be 200 nm to 300 nm.

The silicon-based material may be amorphous.

The anode active material may include 80 wt % to 95 wt % of the carbon-based material and ₅ wt % to 20 wt % of the silicon-based material.

Another embodiment of the present disclosure provides an anode for an all-solid-state battery, including the anode active material described above and a solid electrolyte, in which the silicon-based material may be disposed between two or more adjacent layers of carbon-based material, and a space between the silicon-based material and the carbon-based material may be filled with the solid electrolyte.

Still another embodiment of the present disclosure provides a method of manufacturing an anode active material for an all-solid-state battery, including manufacturing a carbon-based material by forming a coating layer including amorphous carbon from a hydrocarbon gas on the surface of carbon-based particles through thermal chemical vapor deposition, manufacturing a silicon-based material through thermal chemical vapor deposition using a feed including silane gas and ammonia gas, and mixing the carbon-based material and the silicon-based material.

The carbon-based particles may include at least one selected from the group consisting of synthetic graphite, natural graphite, and combinations thereof, and may have an average particle diameter (D₅₀) of 10 μm or less.

The hydrocarbon gas may include acetylene.

The feed including the silane gas and the ammonia gas may have nitrogen (N) content of 6 at % to 10 at %.

The silicon-based material may be synthesized from the silane gas and the ammonia gas at a temperature of 600° C. to 800° C. for 5 hours to 7 hours.

The manufacturing method may further include heat-treating the silicon-based material at a temperature of 800° C. to 1,000° for 1 hour to 3 hours in a nitrogen atmosphere, after synthesizing the silicon-based material.

According to embodiments of the present disclosure, since a coating layer included in a carbon-based material is capable of blocking direct contact between carbon-based particles and a solid electrolyte, side reactions can be prevented from occurring at the interface therebetween, and the performance of an all-solid-state battery can be greatly improved.

In addition, according to embodiments of the present disclosure, a silicon-based material, which contains nitrogen (N) and thus exhibits superior structural stability at the time of electrochemical charging and discharging, is applied as the anode active material together with the carbon-based material, whereby the capacity and lifetime of the all-solid-state battery can be greatly improved.

The effects of embodiments of the present disclosure are not limited to the foregoing, and should be understood to include all effects that can be reasonably anticipated from the following description.

### BRIEF DESCRIPTION OF THE DRAWINGS

For a more complete understanding of embodiments of the present invention, and the advantages thereof, reference is now made to the following descriptions taken in conjunction with the accompanying drawings, in which:

FIG. 1 shows an all-solid-state battery according to embodiments of the present disclosure;

FIG. 2 is an enlarged view of a portion A of the anode shown in FIG. 1;

FIG. 3 shows a carbon-based material according to embodiments of the present disclosure;

FIG. 4 is a flowchart showing a process of manufacturing an anode active material for an all-solid-state battery according to embodiments of the present disclosure;

FIGS. 5A to 5C show the results of scanning electron microscopy (SEM) performed on the carbon-based material of Preparation Example 1 at different scales;

FIGS. 6A to 6C show the results of SEM performed on the carbon-based material of Comparative Preparation Example 1 at different scales;

FIG. 7A shows the results of SEM performed on the silicon-based material of Preparation Example 2, FIG. 7B shows the results of transmission electron microscope—energy dispersive X-ray spectroscopy (TEM-EDS) performed on the silicon-based material of Preparation Example 2, and FIG. 7C shows the results of X-ray diffraction analysis performed on the silicon-based material of Preparation Example 2;

FIG. 8A shows the results of evaluation of initial coulombic efficiency of Example 1 and Comparative Example 1, and FIG. 8B shows the results of evaluation of the lifetime of the all-solid-state battery of each of Example 1 and Comparative Example 1; and

FIG. 9A shows the results of evaluation of initial coulombic efficiency of Example 1, Example 2, Comparative Example 1 and Comparative Example 2, and FIG. 9B shows the results of evaluation of the lifetime of the all-solid-state battery of each of Example 1, Example 2, Comparative Example 1 and Comparative Example 2.

### DETAILED DESCRIPTION OF ILLUSTRATIVE EMBODIMENTS

The above and other objectives, features and advantages of embodiments of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

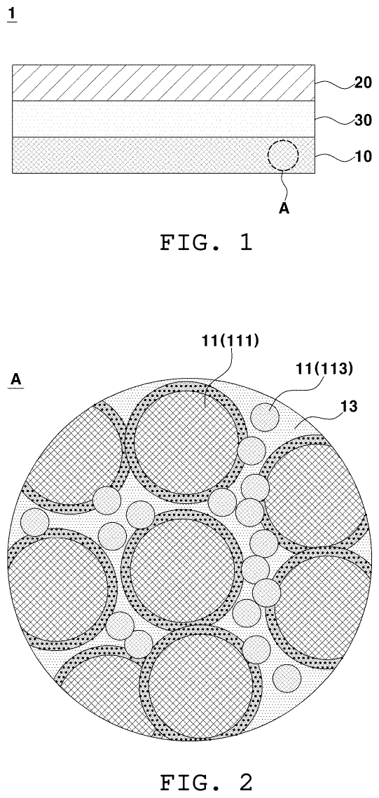

FIG. 1 shows the all-solid-state battery according to embodiments of the present disclosure. With reference thereto, the all-solid-state battery 1 includes an anode 10, a cathode 20, and a solid electrolyte layer 30 disposed between the anode 10 and the cathode 20.

FIG. 2 is an enlarged view of a portion A of the anode 10 shown in FIG. 1. With reference thereto, the anode 10 may include an anode active material 11 and a solid electrolyte 13 provided around the anode active material 11.

As shown in FIG. 2, in embodiments of the present disclosure the anode active material 11 includes both a carbon-based material in and a silicon-based material 113 having high capacity. Accordingly, the charge/discharge capacity of the all-solid-state battery may be greatly improved.

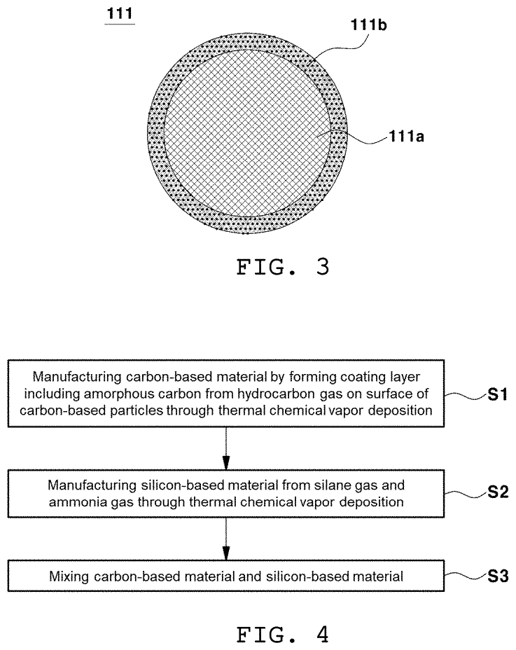

FIG. 3 shows the carbon-based material in according to embodiments of the present disclosure. With reference thereto, the carbon-based material in may include carbon-based particles 111a and a coating layer 111b covering at least a portion of the surface of the carbon-based particles 111a.

In embodiments of the present disclosure, the coating layer 111b including amorphous carbon is formed on the surface of the carbon-based particles 111a to block direct contact between the carbon-based particles 111a and the solid electrolyte 13. In particular, the coating layer 111b may be manufactured through thermal chemical vapor deposition (thermal CVD), so the coating layer 111b may be uniformly formed on the surface of the carbon-based particles 111a, which will be described later.

According to embodiments of the present disclosure, since a side reaction is prevented from occurring at the interface between the carbon-based particles 111a and the solid electrolyte 13 by the coating layer 111b, the charge/discharge capacity and lifetime of the all-solid-state battery may be improved.

The carbon-based particles 111a may include at least one selected from the group consisting of synthetic graphite, natural graphite, and combinations thereof.

The average particle diameter (D₅₀) of the carbon-based particles 111a is not particularly limited, and may be, for example, 10 μm or less, or 1 μm to 10 μm.

The thickness of the coating layer 111b is not particularly limited, and may be, for example, 15 nm to 20 nm.

The carbon-based material in may include 90 wt % to 95 wt % of the carbon-based particles 111a and 5 wt % to 10 wt % of the coating layer 111b. If the amount of the coating layer 111b is less than 5 wt %, the surface of the carbon-based particles 111a may not be uniformly covered, or contact between the carbon-based particles 111a and the solid electrolyte 13 may not be prevented. On the other hand, if the amount of the coating layer 111b exceeds 10 wt %, the relative amount of the carbon-based particles 111a may be decreased, so the performance of the battery may be deteriorated.

The silicon-based material 113 is a material having high theoretical capacity as an active material. Meanwhile, embodiments of the present disclosure use a material containing nitrogen (N) as the silicon-based material 113. Unlike conventional silicon (Si), silicon oxide (SiOₓ), etc., the silicon-based material 113 contains nitrogen (N), and thus an inactive phase made of Si—N may be formed and structural deterioration may be reduced as a result. Accordingly, the charge/discharge capacity of the all-solid-state battery including the silicon-based material 113 may be improved and the lifetime thereof may also be prolonged.

The silicon-based material 113 may include a compound represented by SiNₓ (0<x<2).

The silicon-based material 113 may be nano-sized particles having an average particle diameter (D₅₀) of 200 nm to 300 nm.

The silicon-based material 113 may be amorphous.

The anode active material 11 may include 80 wt % to 95 wt % of the carbon-based material in and 5 wt % to 20 wt % of the silicon-based material 113. If the amount of the silicon-based material 113 is less than 5 wt %, the effect of addition thereof may be insignificant. On the other hand, if the amount thereof exceeds 20 wt %, the volume expansion rate of the anode active material 11 may become too large, which may reduce the durability of the all-solid-state battery.

The solid electrolyte 13 is a component responsible for the movement of lithium ions in the anode 10. The solid electrolyte 13 is not particularly limited, and may be, for example, an oxide-based solid electrolyte or a sulfide-based solid electrolyte. It is desirable to use a sulfide-based solid electrolyte having high lithium ionic conductivity.

The sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one of Ge, Zn and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga and In), Li₁₀GeP₂S₁₂, etc.

FIG. 4 is a flowchart showing the process of manufacturing an anode active material for an all-solid-state battery according to embodiments of the present disclosure. With reference thereto, the method includes manufacturing a carbon-based material by forming a coating layer including amorphous carbon from a hydrocarbon gas on the surface of carbon-based particles through thermal CVD (S1), manufacturing a silicon-based material through thermal CVD using a feed including silane gas and ammonia gas (S2), and mixing the carbon-based material and the silicon-based material (S3).

The carbon-based material and the silicon-based material are as described above, and a detailed description thereof is omitted below.

In embodiments of the present disclosure, the coating layer is manufactured through thermal CVD using a hydrocarbon gas in order to uniformly form a coating layer including amorphous carbon on the surface of the carbon-based particles. Specifically, a hydrocarbon gas is subjected to thermal vapor decomposition, whereby a thin and uniform coating layer of amorphous carbon may be formed on the surface of the carbon-based particles.

The hydrocarbon gas may include acetylene. Here, argon gas, hydrogen gas, nitrogen gas, or the like may be further introduced as a carrier gas together with the hydrocarbon gas.

The silicon-based material may be synthesized using the feed including silane gas and ammonia gas at a temperature of 600° C. to 800° C. for 5 hours to 7 hours through thermal CVD.

Here, the feed including silane gas and ammonia gas may have a nitrogen (N) content of 6 at % to 10 at %. If the nitrogen (N) content in the feed exceeds 10 at %, electrode resistance may increase during synthesis, and the charge/discharge capacity of the silicon-based material may decrease.

Also, the manufacturing method may further include heat-treating the silicon-based material at a temperature of 800° C. to 1,000° C. for 1 hour to 3 hours in a nitrogen atmosphere after completion of synthesis.

The process of mixing the carbon-based material and the silicon-based material is not particularly limited, and may be dry mixing or wet mixing, and a device commonly used in the art to which the present disclosure belongs, such as a mixer, etc., may be used.

A better understanding of embodiments of the present disclosure may be obtained through the following examples. These examples are merely set forth to illustrate embodiments of the present disclosure, and are not to be construed as limiting the scope of the present disclosure.

### PREPARATION EXAMPLE 1 AND COMPARATIVE PREPARATION EXAMPLE 1

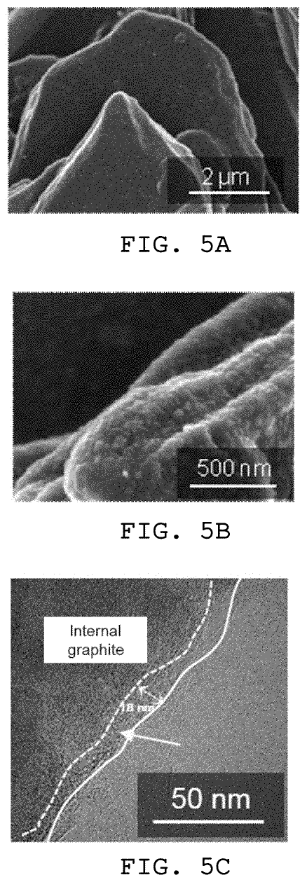

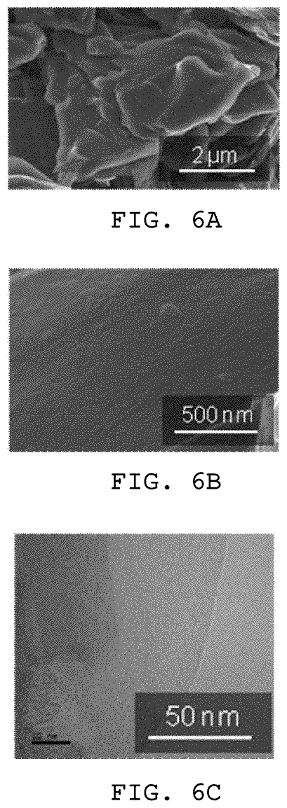

In Preparation Example 1, synthetic graphite having an average particle diameter (D₅₀) of about 10 μm was used as carbon-based particles, acetylene was used as a hydrocarbon gas, and a coating layer including amorphous carbon was formed on the surface of the carbon-based particles through thermal CVD. Scanning electron microscopy (SEM) was performed thereon. The results thereof are shown in FIGS. 5A to 5C.

On the other hand, in Comparative Preparation Example 1, intact carbon-based particles not including a coating layer were used. SEM was performed thereon. The results thereof are shown in FIGS. 6A to 6C.

Based on the above results, it can be found that the carbon-based material of Preparation Example 1 was configured such that the surface of synthetic graphite was uniformly coated with amorphous carbon, and there was no significant change in particle size or distribution. In particular, with reference to FIG. 5C, it can be seen that the thickness of the coating layer of amorphous carbon was evenly formed at a level of about 20 nm.

### PREPARATION EXAMPLE 2

A silicon-based material was synthesized using a feed including silane gas and ammonia gas through thermal CVD. In the feed, nitrogen (N) content was adjusted to about 10 at %, and synthesis was performed at about 700° C. for about 6 hours.

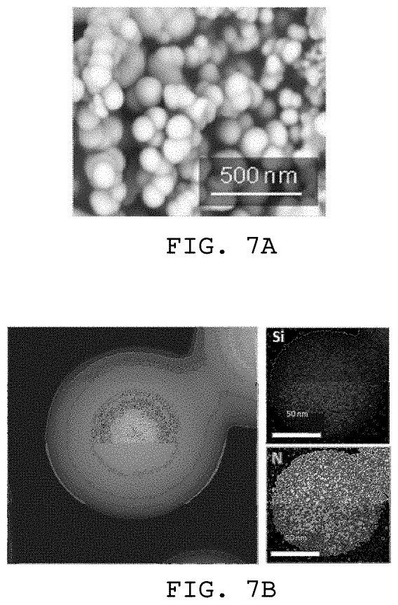

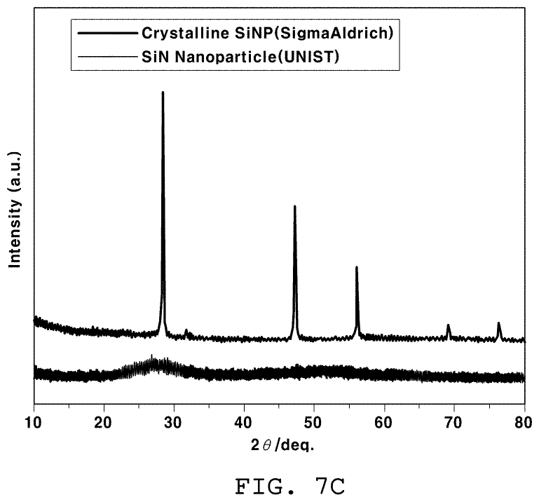

FIG. 7A shows the results of SEM performed on the silicon-based material. FIG. 7B shows the results of TEM-EDS (transmission electron microscope—energy dispersive X-ray spectroscopy) performed on the silicon-based material. FIG. 7C shows the results of X-ray diffraction analysis performed on the silicon-based material.

As shown in FIG. 7A, the average particle diameter (D₅₀) of the silicon-based material was 200 nm to 300 nm, and the size distribution thereof was uniform. As shown in FIG. 7B, Si and N were uniformly mixed. In addition, it can be inferred that the silicon-based material was amorphous based on the fact that the peak indicating crystalline Si was not observed in FIG. 7C.

### EXAMPLE 1 AND COMPARATIVE EXAMPLE 1

In Example 1, in order to verify the effectiveness of the carbon-based material of Preparation Example 1, half-cell evaluation of an all-solid-state battery including the carbon-based material of Preparation Example 1 was performed.

Specifically, an electrochemical cell (Premium Glass Co., Ltd) was used, and a mixture including the carbon-based material, a sulfide-based solid electrolyte, and a binder at a weight ratio of 75:24:1 was pressed to make a pellet-shaped anode. The loading level depending on the weight and area of the anode was adjusted to about 11 mg/cm².

The sulfide-based solid electrolyte was pressed for about 10 seconds at a pressure of about 10 MPa to form a pellet. Thereafter, a cathode composite and an anode were placed on both sides thereof and then pressed for about 5 minutes at a pressure of about 32 MPa to complete the cell.

In order to evaluate the initial coulombic efficiency, the assembled cell was paused for 4 hours, charged in constant current (CC) mode to −0.615 V at 0.1 C, and then discharged in CC mode to 1.38 V at 0.1 C.

The all-solid-state battery of Comparative Example 1 was manufactured in the same manner as in Example 1, with the exception that the carbon-based material of Comparative Preparation Example 1 (intact carbon-based particles not including a coating layer) was used, and the charge/discharge evaluation thereof was performed in the same manner as above.

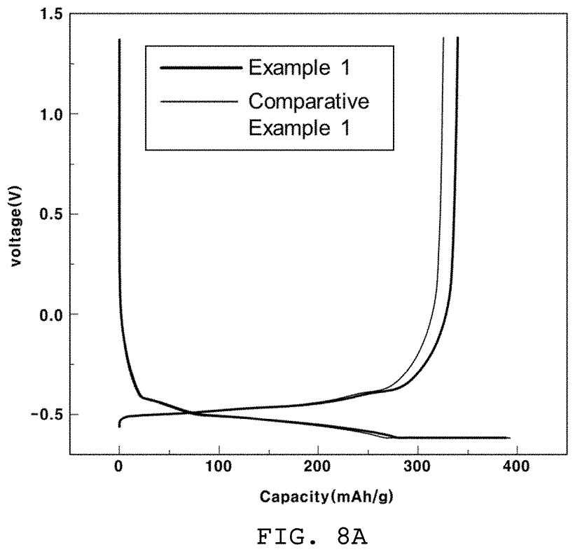

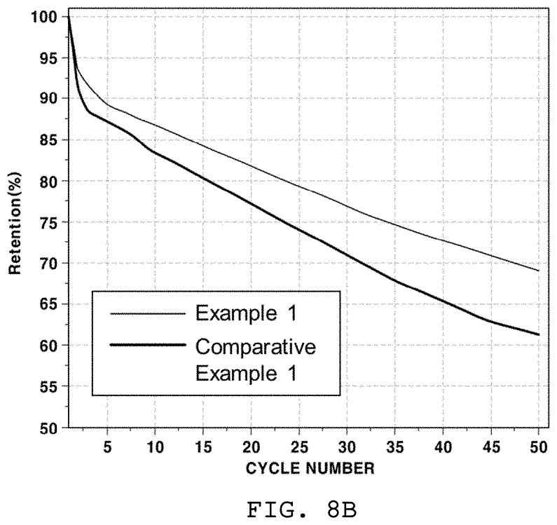

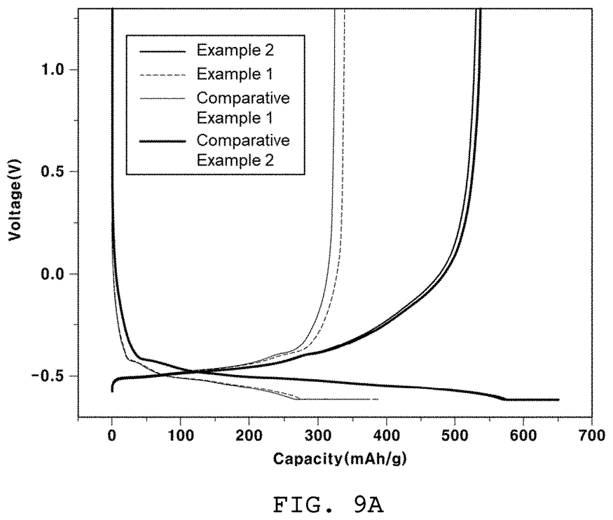

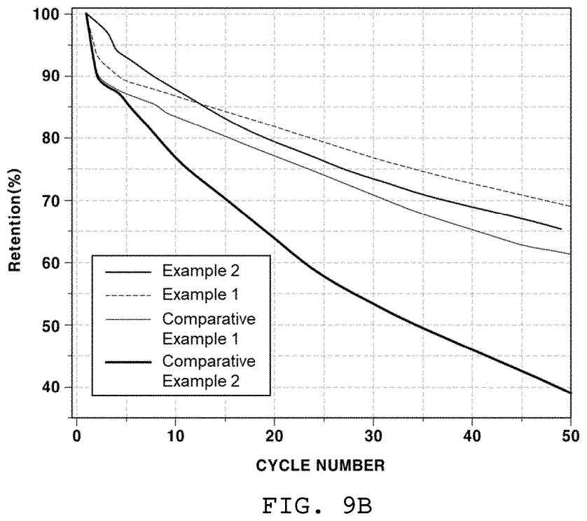

FIG. 8A shows the results of evaluation of the initial coulombic efficiency of Example 1 and Comparative Example 1, and FIG. 8B shows the results of evaluation of the lifetime of the all-solid-state battery of each of Example 1 and Comparative Example 1. The charge/discharge capacity, initial coulombic efficiency, and capacity retention after 50 charge/discharge cycles of Example 1 and Comparative Example 1 are shown in Table 1 below.

TABLE 1

| | Discharge | Charge | Initial coulombic | Capacity |
|---|---|---|---|---|
| | capacity | capacity | efficiency | retention |
| Classification | [mAh/g] | [mAh/g] | [%] | [%] |
| Example 1 | 340.6 | 387.2 | 87.8 | 70.1 |
| Comparative | 325.8 | 368.0 | 88.5 | 60.5 |
| Example 1 | | | | |

As is apparent from FIG. 8A and Table 1, the all-solid-state battery of Example 1 had high charge/discharge capacity. Also, as is apparent from FIG. 8B and Table 1, the capacity retention of the all-solid-state battery of Example 1 after 50 charge/discharge cycles was improved by about 10% or more.

### EXAMPLE 2 AND COMPARATIVE EXAMPLE 2

The all-solid-state battery of Example 2 was manufactured in the same manner as in Example 1, with the exception that the carbon-based material of Preparation Example 1 and the silicon-based material of Preparation Example 2 were mixed. Here, 83 wt % of the carbon-based material and 17 wt % of the silicon-based material were mixed.

The all-solid-state battery of Comparative Example 2 was manufactured in the same manner as in Example 2, with the exception that the carbon-based material of Preparation Example 1 and amorphous silicon were mixed.

FIG. 9A shows the results of evaluation of the initial coulombic efficiency of Example 1, Example 2, Comparative Example 1 and Comparative Example 2, and FIG. 9B shows the results of evaluation of the lifetime of the all-solid-state battery of each of Example 1, Example 2, Comparative Example 1 and Comparative Example 2. The charge/discharge capacity, initial coulombic efficiency, and capacity retention after 50 charge/discharge cycles of Example 1, Example 2, Comparative Example 1 and Comparative Example 2 are shown in Table 2 below.

TABLE 2

| | Discharge | Charge | Initial coulombic | Capacity |
|---|---|---|---|---|
| | capacity | capacity | efficiency | retention |
| Classification | [mAh/g] | [mAh/g] | [%] | [%] |
| Example 2 | 531.1 | 641.4 | 82.8 | 65.3 |
| Example 1 | 340.6 | 387.2 | 87.8 | 70.1 |
| Comparative | 325.8 | 368.0 | 88.5 | 60.5 |
| Example 1 | | | | |
| Comparative | 539.1 | 650.3 | 82.9 | 39.9 |
| Example 2 | | | | |

As is apparent from FIG. 9A and Table 2, the all-solid-state battery of Example 2 exhibited a discharge capacity of 531.1 mAh/g. With reference to FIG. 9B and Table 2, in Comparative Example 2, the charge/discharge capacity was high but capacity retention was very poor. However, the capacity retention of the all-solid-state battery of Example 2 after 50 charge/discharge cycles was improved by about 25% or more compared to Comparative Example 2. In particular, as judged through the slope of the capacity reduction in FIG. 9B, it can be found that there were no additional side effects due to the capacity reduction by virtue of the silicon-based material in Example 2.

Although specific embodiments of the present disclosure have been described with reference to the accompanying drawings, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. An anode active material for an all-solid-state battery, the anode active material comprising:
a carbon-based material comprising carbon-based particles and a coating layer formed on a surface of the carbon-based particles, the coating layer comprising amorphous carbon; and
a silicon-based material.

2. The anode active material of claim 1, wherein the carbon-based particles comprise at least one material selected from the group consisting of synthetic graphite, natural graphite, and combinations thereof.

3. The anode active material of claim 1, wherein an average particle diameter of the carbon-based particles is 10 μm or less.

4. The anode active material of claim 1, wherein a thickness of the coating layer is 15 nm to 20 nm.

5. The anode active material of claim 1, wherein the carbon-based material comprises 90 wt % to 95 wt % of the carbon-based particles and 5 wt % to 10 wt % of the coating layer.

6. The anode active material of claim 1, wherein the silicon-based material comprises a compound represented by SiNₓ (0<x<2).

7. The anode active material of claim 1, wherein an average particle diameter (D₅₀) of the silicon-based material is 200 nm to 300 nm.

8. The anode active material of claim 1, wherein the silicon-based material is amorphous.

9. The anode active material of claim 1, wherein the anode active material comprises 80 wt % to 95 wt % of the carbon-based material and 5 wt % to 20 wt % of the silicon-based material.

10. An anode for an all-solid-state battery, the anode comprising:
an anode active material comprising a carbon-based material and a silicon-based material, the carbon-based material comprising carbon-based particles and a coating layer formed on a surface of the carbon-based particles, the coating layer comprising amorphous carbon; and
a solid electrolyte,
wherein the silicon-based material is disposed between two or more adjacent layers of the carbon-based material, and a space between the silicon-based material and the carbon-based material is filled with the solid electrolyte.

11. A method of manufacturing an anode active material for an all-solid-state battery, the method comprising:
manufacturing a carbon-based material by forming a coating layer comprising amorphous carbon from a hydrocarbon gas on a surface of carbon-based particles through thermal chemical vapor deposition;
manufacturing a silicon-based material through thermal chemical vapor deposition using a feed comprising silane gas and ammonia gas; and
mixing the carbon-based material and the silicon-based material.

12. The method of claim 11, wherein the carbon-based particles comprise at least one selected from the group consisting of synthetic graphite, natural graphite, and combinations thereof, and have an average particle diameter of 10 μm or less.

13. The method of claim 11, wherein the hydrocarbon gas comprises acetylene.

14. The method of claim 11, wherein a thickness of the coating layer is 15 nm to 20 nm.

15. The method of claim 11, wherein the carbon-based material comprises 90 wt % to 95 wt % of the carbon-based particles and 5 wt % to 10 wt % of the coating layer.

16. The method of claim 11, wherein the feed comprising the silane gas and the ammonia gas has a nitrogen (N) content of 6 at % to 10 at %.

17. The method of claim 11, wherein the silicon-based material is synthesized from the silane gas and the ammonia gas at a temperature of 600° C. to 800° C. for 5 hours to 7 hours.

18. The method of claim 17, further comprising heat-treating the silicon-based material at a temperature of 800° C. to 1,000° for 1 hour to 3 hours in a nitrogen atmosphere, after synthesizing the silicon-based material.

19. The method of claim 11, wherein the silicon-based material comprises a compound represented by SiNₓ (0<x<2) and has an average particle diameter of 200 nm to 300 nm.

20. The method of claim 11, wherein the silicon-based material is amorphous.
